(19) United States
(12) Patent Application Publication
(10) Pub. No.: US 2014/0035877 A1
(43) Pub. Date: Feb. 6, 2014

(54) USING A DISPLAY DEVICE WITH A TRANSPARENT DISPLAY TO CAPTURE INFORMATION CONCERNING OBJECTIVES IN A SCREEN OF ANOTHER DISPLAY DEVICE

(71) Applicants: YI-WEN CAI, Tu-Cheng (TW); SHIH-CHENG WANG, Tu-Cheng (TW)

(72) Inventors: YI-WEN CAI, Tu-Cheng (TW); SHIH-CHENG WANG, Tu-Cheng (TW)

(73) Assignee: HON HAI PRECISION INDUSTRY CO., LTD., Tu-Cheng (TW)

(21) Appl. No.: 13/563,865

(22) Filed: Aug. 1, 2012

(51) Int. Cl. G06F 3/042

(52) U.S. Cl. 345/175

(57) ABSTRACT

Information in a screen of another display device such as a television or a computer monitor can be captured by a display device including a transparent display, a camera unit, an input unit, and a control unit. The transparent display allows a user to view the screen through the transparent display. The camera unit produces screen images corresponding to the screen. The input unit produces selection parameters in response to a selection operation corresponding to a virtual image of the screen seen through the transparent display. The control unit determines objective(s) in the screen according to the screen images and the selection parameters. The control unit may transmit the objective data corresponding to the objective(s) to the transparent display, thereby enabling the transparent display to display objective-related information corresponding to the objective according to objective data.

### BACKGROUND

1. Technical Field

The present disclosure relates to a display device, and particularly to a display device with a transparent display which is capable of capturing information as to objectives in a screen of another display device.

2. Description of Related Art

Televisions are used to spread important information such as security or fire related messages. However, the important information provided through televisions is usually quite brief and cannot satisfy all of the viewers in different areas. Although an additional electronic device such as a tablet computer or a smart phone can be used as a second screen to allow the viewers to interact with the content they are viewing, the keywords of the important information usually have to be manually keyed in by the viewers while mistakes are liable to appear when keying in the keywords.

Thus, there is room for improvement in the art.

### BRIEF DESCRIPTION OF THE DRAWINGS

Many aspects of the present disclosure can be better understood with reference to the drawings. The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a display device of the present disclosure.

FIG. 2 is a schematic diagram of determining the direction of the vision line through the control unit shown in FIG. 1.

FIG. 3 is a schematic diagram of displaying objective-related information through the transparent display shown in FIG. 1.

FIG. 4 is a flowchart of an embodiment of a monitoring method implemented through the display device shown in FIG. 1.

### DETAILED DESCRIPTION

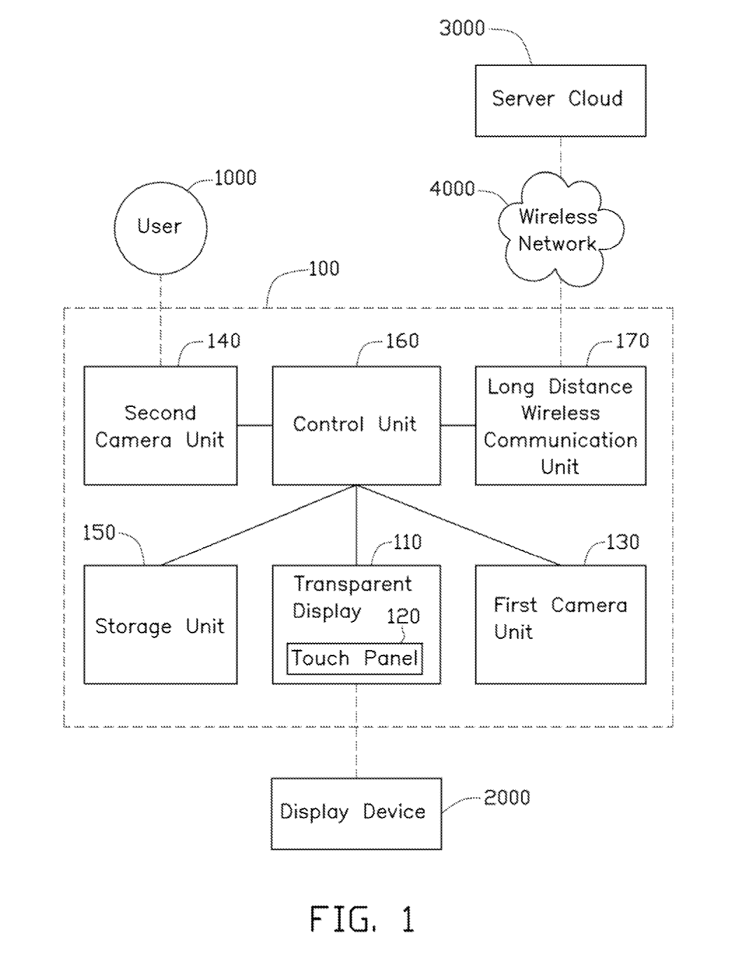

FIG. 1 is a block diagram of an embodiment of a display device 100 of the present disclosure. In the illustrated embodiment, the display device 100 is a portable electronic device such as a tablet computer, a notebook computer, or a smart phone. In other embodiments, the display device can be another type of electronic device such as a computer monitor. The display device 100 includes a transparent display 110, a touch panel 120, a first camera unit 130, a second camera unit 140, a storage unit 150, a control unit 160, and a long distance wireless communication unit 170. In the illustrated embodiment, the transparent display 110 is a transparent active-matrix organic light-emitting diode (AMOLED) display, which allows a user 1000 of the display device 100 to view a screen of another display device 2000 through the transparent display 110, wherein the display device 2000 can be a display device such as a television, a computer monitor, or a portable electronic device, or another type of electronic device including a display. In other embodiments, the transparent display 110 can be another type of transparent/translucent display such as a transparent liquid crystal display (LCD) display. In addition, the transparent display 110 can be a device with a transparent portion such as a glass and a projector capable of projecting on the transparent portion.

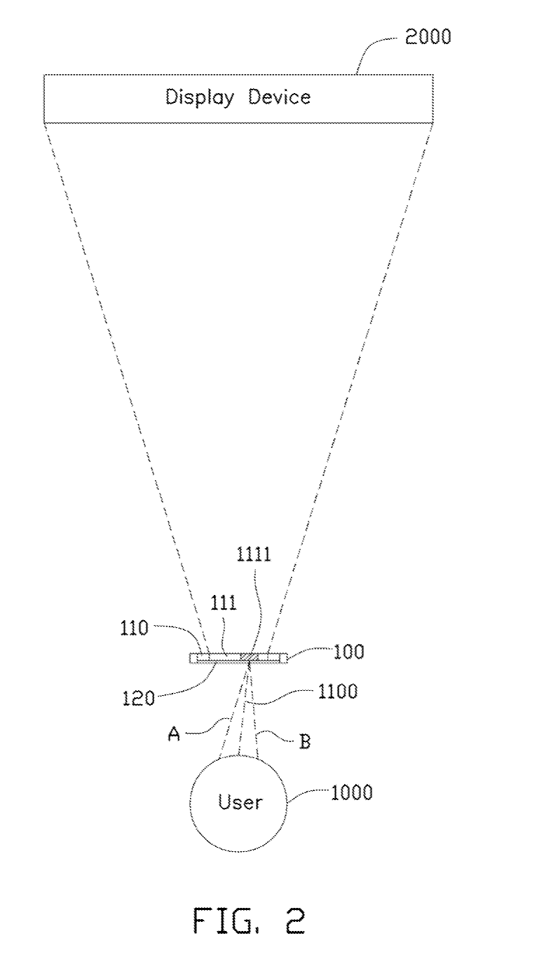

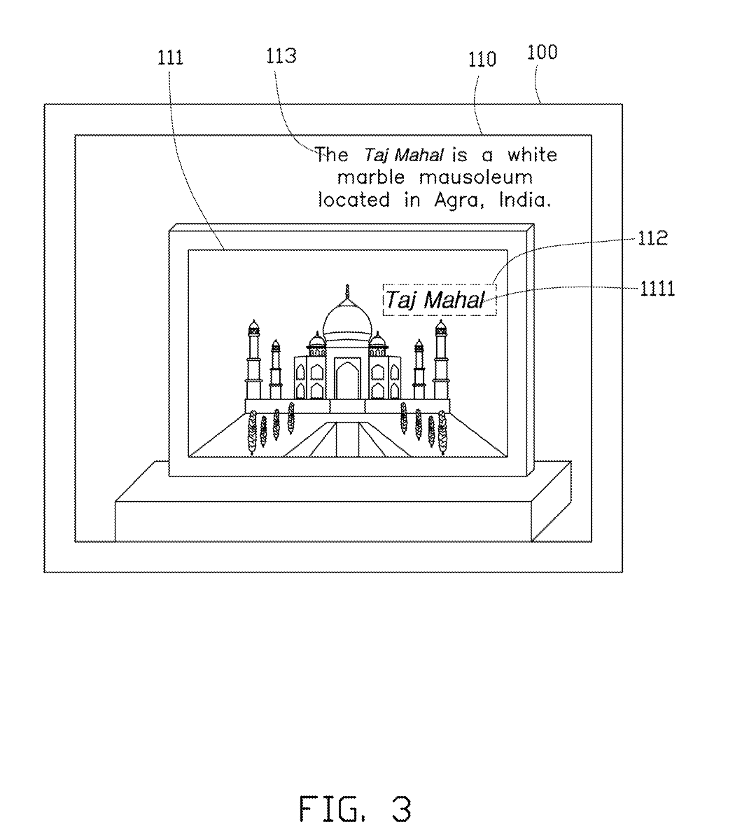

In the illustrated embodiment, the touch panel 120 is disposed on the transparent display 110 to correspond to a transparent portion of the transparent display 110, such that touch operations with respect to the touch panel 120 can be performed with respect to a virtual image 111 (see FIG. 2 and FIG. 3) of the screen seen through the transparent display 110. The touch panel 120 has a coordinate system corresponding to a coordinate system of the transparent display 110. When a touch operation including, for example, a press (and a drag), is detected by the touch panel 120, the touch panel 120 produces touch position parameter(s) corresponding to the touch operation which includes coordinate(s) of the touch panel 120 corresponding to the touch operation. In other embodiments, another type of input device such as a mouse can be used to produce selection parameter(s) in response to a selection operation performed with respect to the virtual image 111 of the screen on the transparent display 110.

The first camera unit 130 produces screen images Gs (not shown), which includes camera(s) producing the screen images Gs such as still photographs or videos. The screen images Gs may include a portrait of the screen which can be viewed through the transparent display 110. The second camera unit 140 produces user images Gu (not shown) which may include a portrait of the user 1000, which includes camera(s) producing the user images Gu such as still photographs or videos. In the illustrated embodiment, the first camera unit 130 is disposed at a side of the display device 100 facing the display device 2000, while the second camera unit 140 is disposed at another side of the display device 100 opposite to the side which faces the user 1000. The storage unit 150 is a device such as a high speed random access memory, a non-volatile memory, or a hard disk drive for storing and retrieving digital information, which stores sample objective data Ds (not shown) including sample objective figures. In the illustrated embodiment, the sample objective figures are figures of possible objectives such as characters or graphs to be recognized.

The control unit 160 receives the touch position parameter(s) from the touch panel 120, the screen image Gs from the first camera unit 130, and the user images Gu from the second camera unit 140. The control unit 160 then determines an indicating direction of the user 1000 through the user images Gu. The control unit 160 further determines possible objective(s) Op (not shown) through the screen image Gs according to the touch position parameter(s) and the indicating direction, and recognizes objective(s) O (not shown) in the screen from the possible objective(s) Op according to the sample objective data Ds, thereby determining the objective(s). In the illustrated embodiment, the control unit 160 determines the indicating direction of the user 1000 by determining the direction of a vision line 1100 of the user 1000. FIG. 2 is a schematic diagram of determining the direction of the vision line 1100 through the control unit 160 shown in FIG. 1. The control unit 160 determines a first direction A and a second direction B of the eye balls of the user 1000 which are on the geometric centerline of the cornea of the eye balls of the user 1000 according to one or a series of the user images Gu, and determines a direction on the centerline between the first direction A and the second direction B as the direction of the vision line 1100 of the user 1000. In other embodiments, the control unit 160 can determine the indicating direction of the user 1000 according to other characteristics of the user 1000, for example, the direction of the face of the user 1000 or indicating gestures of the user 1000 (accordingly, the indicating direction can be the direction of a forefinger of the user 1000).

In the illustrated embodiment, the control unit 160 analyzes the screen image Gs to determine a portion of the screen image which corresponds to a FIG. 1111 (see FIG. 2 and FIG. 3) of the virtual image 111 in the vision line 1100 of the user 1000 and includes pixels having coordinates corresponding to the coordinate(s) in the touch position parameter(s) as the possible objective(s) Op. The control unit 160 compares the possible objective(s) Op with the sample objective figures in the sample objective data Ds to recognize characters and/or graphs displayed on the screen, and determine the objective(s) O according to the recognized characters and/or graphs. The objective(s) O can be, for example, characters, words, or sentences composed of the recognized characters, or graphs corresponding to the recognized graphs. For instance, a serious of the recognized characters can be recognized as the objective(s) O when the characters compose a term. In other embodiments, the control unit 160 can analyze the screen image Gs to determine a portion of the screen image which corresponds to the FIG. 1111 of the virtual image 111 in a direction from a particular position and includes the pixels having the coordinates corresponding to the coordinate(s) in the touch position parameter(s) as the possible objective(s) Op, wherein the particular position can be, for example, a position opposite to a geometric center of a surface of the transparent display 110 where the user 1000 can view the contents displayed through the transparent display 110. Correspondingly, the second camera unit 140 is unnecessary.

In the illustrated embodiment, the FIG. 1111 corresponding to the objective(s) O is highlighted through a dashed box 112 (see FIG. 3) after the objective(s) O is determined, thereby differentiating the FIG. 1111 from other portions of the screen. In addition, a relative location compensation unit can be used to determine a difference between the relative location (for example, the relative distance and/or the relative direction) between the user 1000 (or the particular position) and the display device 2000 as well as the relative location between the first camera unit 130 and the display device 2000. Correspondingly, the control unit 160 can compensate the difference by enabling the first camera unit 130 to zoom in or re-orientate according to the difference, such that the screen images Gs produced by the first camera unit 130 correspond to the virtual image 111 viewed by the user 1000. The control unit 160 can also compensate the difference by enabling the control unit 160 to consider the difference when recognizing the objective(s), thereby eliminating any inaccuracy between the display and the factual situations, which are caused by the difference.

The control unit 160 transmits objective data Do (not shown) including information concerning the objective(s) O to the transparent display 110. The information concerning the objective(s) O can be brief introductions of the objective(s), details of the objective(s), related information of the objective(s), or other types of information with respect to the objective(s) O, for example, hyperlinks with respect to the objective(s) O or window components such as buttons for invoking a computer program. The information concerning the objective(s) O can be pre-stored in the storage unit 150, or be received from a server cloud 3000 communicating with the display device 100 through a wireless network 4000 implemented according to a telecommunication standard such as BLUETOOTH, WI-FI, and GSM (Global System for Mobile Communications). The control unit 160 transmits request information including the objective(s) O to the server cloud 3000 and receives the information concerning the objective(s) O corresponding to the request information from the server cloud 3000 through the wireless communication unit 170 connected to the wireless network 4000.

In other embodiments, the storage unit 150 may include customized information such as personal information of the user 1000, such that the control unit 160 can transmit the objective data Do including the information concerning the objective(s) O corresponding to the customized information. For instance, the control unit 160 can receive the information concerning the objective(s) O corresponding to the scope defined in the personal information of the user 1000, thereby providing the information, which the user 1000 requests. In addition, the display device 100 may include sensing units for detecting environmental parameters such as location, direction, temperature, and/or humidity of the area where the display device 100 is located, such that the control unit 160 can transmit the objective data Do including the information concerning the objective(s) O corresponding to the environmental parameters. For instance, the sensing unit can be a GPS (Global Positioning System) receiver which is capable of producing a location information representing latitude, longitude, and/or elevation of display device 100. During this time the control unit 160 can receive the information concerning the objective(s) O corresponding to the location information, thereby providing the information with respect to the location of the display device 100, for example, the local information of the area where the display device 100 is located.

The transparent display 110 receives the objective data Do from the control unit 160. FIG. 3 is a schematic diagram of displaying objective-related information 113 through the transparent display 11 shown in FIG. 1. The transparent display 110 displays the objective-related information 113 according to the objective data Do. The objective-related information 113 representing the information concerning the objective(s) O is displayed on a position of the transparent display 110 which is adjacent to the position of the FIG. 1111 corresponding to the objective(s) O. The control unit 160 can transmit the objective data Do in response to the movement of the objective(s) O which caused by, for example, the movement of the display device 100 or the change of the screen of the display device 2000, while the first camera unit 130 traces the objective O when the objective O moves, such that the objective-related information 113 can be displayed to correspond to the position of the FIG. 1111.

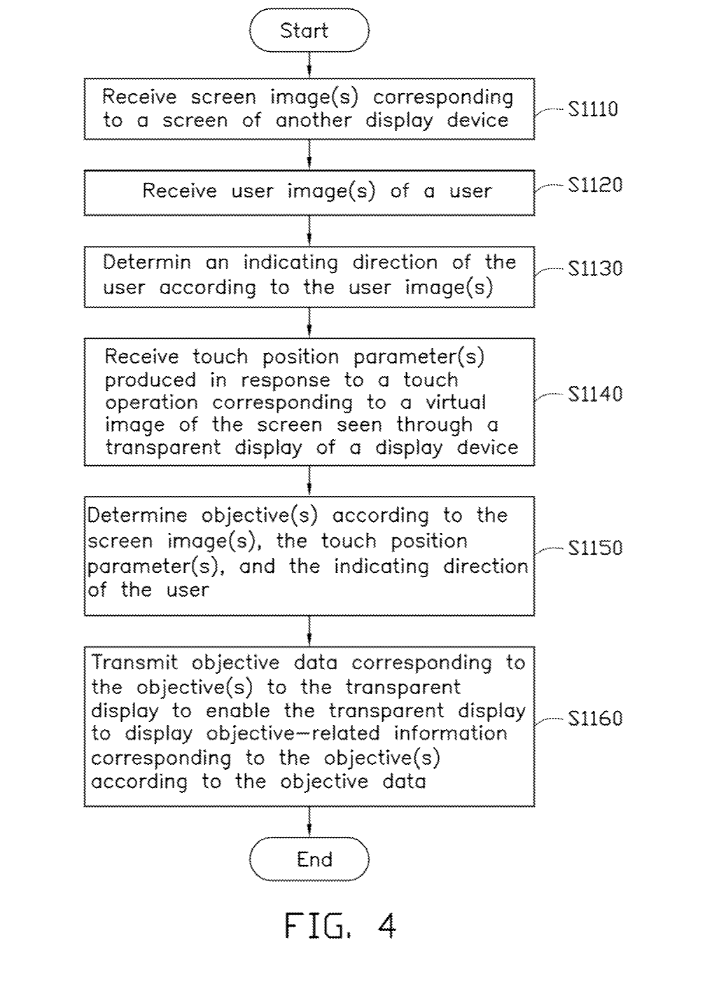

FIG. 4 is a flowchart of an embodiment of a monitoring method implemented through the display device 100 shown in FIG. 1. The monitoring method of the present disclosure follows. Depending on the embodiment, additional steps may be added, others removed, and the ordering of the steps may be changed.

In step S1110, the screen images Gs corresponding to a screen of the display device 2000 are received.

In step S1120, the user images Gu of the user 1000 are received.

In step S1130, an indicating direction of the user 1000 is determined according to the user images Gu. In the illustrated embodiment, the indicating direction is determined by determining the direction of the vision line 1100 of the user 1000 through the user images Gu (see FIG. 2),

In step S1140, touch position parameter(s) produced in response to a touch operation corresponding to the virtual image 111 of the screen seen through the transparent display 110 are received.

In step S1150, the objective(s) O are determined according to the screen images Gs, the touch position parameter(s), and the indicating direction of the user 1000. In the illustrated embodiment, the objective(s) O are recognized by analyzing the screen images Gs according to the sample objective data Ds.

In step S1160, the objective data Do corresponding to the objective(s) O are transmitted to the transparent display 110 to enable the transparent display 110 to display objective-related information 113 corresponding to the objective O according to the objective data Do. The objective data Do can be transmitted in response to the movement of the objective O while the objective O is traced when moved, such that the objective-related information 113 can be displayed to correspond to the position of the FIG. 1111. The objective data Do can be received from the server cloud 3000 by transmitting request information corresponding to the objective O to the server cloud 3000 and receive the information concerning the objective O corresponding to the request information from the server cloud 3000 through the wireless communication unit 170.

The display device with a transparent display can be used to capture information concerning objectives in a screen of another display device, and information concerning the objectives such as brief introductions or details of the objectives can be displayed through the transparent display.

While the disclosure has been described by way of example and in terms of preferred embodiment, the disclosure is not limited thereto. On the contrary, it is intended to cover various modifications and similar arrangements as would be apparent to those skilled in the art. Therefore the range of the appended claims should be accorded the broadest interpretation so as to encompass all such modifications and similar arrangements.

What is claimed is:

1. A display device, comprising:
a transparent display allowing a user to view a screen of another display device through the transparent display;
one or more first camera units producing one or more screen images corresponding to the screen;
an input unit, wherein the input unit produces one or more selection parameters in response to a selection operation corresponding to a virtual image of the screen seen through the transparent display; and
a control unit, wherein the control unit determines one or more objectives in the screen according to the one or more screen images and the one or more selection parameters.

2. The display device of claim 1, wherein the transparent display displays one or more objective-related information corresponding to the one or more objectives according to one or more objective data, the control unit transmits the one or more objective data corresponding to the one or more objectives to the transparent display.

3. The display device of claim 2, wherein the one or more first camera units trace the one or more objectives when the one or more objectives move, the control unit transmits the one or more objective data in response to the movement of the one or more objectives.

4. The display device of claim 2, further comprising a wireless communication unit, wherein the control unit transmits one or more request information corresponding to the one or more objectives to the one or more servers through the wireless communication unit, and receives the one or more objective data corresponding to the request information from the one or more servers.

5. The display device of claim 1, wherein the input unit comprises a touch panel disposed on the transparent display, the touch panel produces the one or more selection parameters comprising one or more touch position parameters in response to the selection operation comprising a touch operation with respect to the touch panel.

6. The display device of claim 1, wherein each of the one or more objectives comprises at least one of a character and a graph.

7. The display device of claim 1, further comprising one or more second camera units producing one or more user images corresponding to the user, wherein the control unit determines an indicating direction of the user according to the one or more user images, and determines the one or more objectives according to the one or more screen images, the one or more selection parameters, and the indicating direction of the user.

8. The display device of claim 7, wherein the control unit determines the indicating direction of the user by determining the direction of a vision line of the user through the one or more user images.

9. The display device of claim 1, wherein the transparent display comprises at least one of a transparent active-matrix organic light-emitting diode (AMOLED) display and a transparent liquid crystal display (LCD) display.

10. The display device of claim 1, further comprising a storage unit storing one or more sample objective data, wherein the control unit recognizes the one or more objectives by analyzing the one or more screen images according to the sample objective data when determining the one or more objectives.

11. A display method, comprising:
a display device comprising a transparent display allowing a user to view a screen of another display device through the transparent display;
receiving one or more screen images corresponding to the screen;
receiving one or more selection parameters produced in response to a selection operation corresponding to a virtual image of the screen seen through the transparent display; and
determining one or more objectives in the screen according to the one or more screen images and the one or more selection parameters.

12. The monitoring method of claim 11, further comprising:
transmitting one or more objective data corresponding to the one or more objectives to the transparent display to enable the transparent display to display one or more objective-related information corresponding to the one or more objectives according to the one or more objective data.

13. The monitoring method of claim 12, further comprising:
tracing the one or more objectives when the one or more objectives move, wherein the step of transmitting the one or more objective data comprises transmitting the one or more objective data in response to the movement of the one or more objectives.

14. The monitoring method of claim 12, wherein the display device comprises a wireless communication unit communicating with one or more server, the step of transmitting the one or more objective data comprises:
transmitting one or more request information corresponding to the one or more objectives to the one or more servers through the wireless communication unit;
receiving the one or more objective data corresponding to the request information from the one or more servers through the wireless communication unit;
transmitting the one or more objective data to the transparent display to enable the transparent display to display the one or more objective-related information corresponding to the one or more objectives according to the one or more objective data.

15. The monitoring method of claim 11, wherein the display device comprises a touch panel, the step of receiving the one or more selection parameters comprises: receiving the one or more selection parameters comprising one or more touch position parameters produced in response to the selection operation comprising a touch operation with respect to the touch panel and corresponding to a virtual image of the screen seen through the transparent display.

16. The monitoring method of claim 11, further comprising:
receiving one or more user images corresponding to the user;
determining an indicating direction of the user according to the one or more user images; and
determining the one or more objectives according to the one or more screen images, the one or more selection parameters, and the indicating direction of the user.

17. The monitoring method of claim 16, wherein the step of determining the indicating direction comprises:
determining the direction of a vision line of the user through the one or more user images.

18. A computer program product comprising a non-transitorycomputer readable storage medium and an executable computer program mechanism embedded therein, the executable computer program mechanism comprising instructions for:
receiving one or more screen images corresponding to a screen of another display device viewed through a transparent display of a display device;
receiving one or more selection parameters produced in response to a selection operation corresponding to a virtual image of the screen seen through a transparent display; and
determining one or more objectives in the screen according to the one or more screen images and the one or more selection parameters.

19. The computer program product of claim 18, further comprising:
transmitting one or more objective data corresponding to the one or more objectives to the transparent display to enable the transparent display to display one or more objective-related information corresponding to the one or more objectives according to the one or more objective data.

20. The computer program product of claim 18, wherein the step of receiving the one or more selection parameters comprises:
receiving the one or more selection parameters comprising one or more touch position parameters produced in response to the selection operation comprising a touch operation with respect to a touch panel and corresponding to a virtual image of the screen seen through the transparent display.
